(19) United States
(12) Patent Application Publication
(10) Pub. No.: US 2008/0297144 A1
(43) Pub. Date: Dec. 4, 2008

(54) Method and Device for Measuring the Separation Between Vehicles

(76) Inventor: Jörg Schweizer, Bologna (IT)

Correspondence Address: YOUNG & THOMPSON, 209 Madison Street, Suite 500, ALEXANDRIA, VA, 22314, US

(21) Appl. No.: 11/659,351

(22) PCT Filed: Aug. 4, 2005
(86) PCT No.: PCT/AT05/00312

§ 371 Date: Sep. 24, 2007

(30) Foreign Application Priority Data
Aug. 6, 2004 (IT) BO2004A000510

(51) Int. Cl. G04F 10/00

(52) U.S. Cl. 324/178

(57) ABSTRACT

Device for measuring the separation, between any vehicle of a number of vehicles and the preceding vehicle along a stretch and for a direction, includes a reference conductor and a measuring conductor, along the stretch, the latter including a number of serial separate sections. Each section is electrically-connected to the previous section, via a diode. A constant current generator is provided in each vehicle, whose contacts are each connected to a section of the measuring conductor, corresponding to the position of the vehicle and to the reference conductor, via first and second moving contacts. Each second electric contact is connected to a segment, following the section, lying behind the first electrical contact, the direction of travel, via a corresponding third moving electrical contact. The contacts of the constant current generator form an output, which provides a voltage signal correlated to the distance between the relevant vehicle and the previous vehicle.

The invention relates to a process and an arrangement for measuring the spacing of transport means, such as vehicles, especially of vehicles moving in succession over a distance (road, rail) in one direction. The invention relates to the domain involving control of transport means (vehicles) in motion and also to a means and a process for measuring the interval between vehicles, especially any two successive vehicles in a column of vehicles which is moving.

Means are known, for example distance measuring instruments, which work on the basis of lasers or with ultrasound, and which make it possible to measure the distance from an obstacle. These known means however often work erroneously and are expensive and sensitive due to their complex structure.

Means are also known which are conventionally used to exchange digital data between two trains with the object of stopping the following train when a connection is broken over a certain time interval which is greater than a given safety boundary value (for example 2 seconds). These known means also have the disadvantage that they have a complex structure and can be subject to faults and interference.

The object of this invention is to make available a simple and reliable means (device) and a similar process for measuring (detecting) the interval between transport means (vehicles).

This object is achieved with a process and with a means which have the features of the independent claims.

With the invention a reliable process and a reliable, durable means (arrangement) which is moreover able to display anomalies and faults are proposed.

In one sample embodiment the invention contains a means for measuring the interval (dₙ) between any vehicle (Vₙ) from a host of vehicles (V) and the vehicle (Vₙ₋₁) travelling in front of it, the vehicles moving along a distance (rail, road, or the like) and in one direction. This means located along the entire distance contains a reference conductor (LG) and a measurement conductor (LD). The measurement conductor (LD) consists of several successive segments (Sₘ) which are separated electrically from one another, of which each has a certain length (l). The segments (Sₘ) of the measurement conductor (LD) are electrically connected by a diode (D) to the segment (Sₘ₋₁) which is preceding relative to the direction of travel.

In one sample embodiment of the invention, there is a constant current generator (Gₙ) in each vehicle which is moving along a certain distance and in a certain direction. The contacts of the constant current generator (Gₙ), first contacts (Pₙ) and second contacts (Qₙ) are each electrically connected to a segment (Sₘ) of the measurement conductor (LD) corresponding to the position of the vehicle (Vₙ) and to the reference conductor (LG) movably along them.

The second contact for electrical connection (Qₙ) is preferably connected by a corresponding third movable electrical connection (contact Tₙ) to a segment (Sₖ) of the measurement conductor (LD) following the segment (Sₘ) which is located downstream of the first electrical connection (Pₙ).

The contacts of the constant current generator (Gₙ) form especially one output Eₙ) which makes available a voltage signal which is correlated with the interval (dₙ) between the corresponding vehicle (Vₙ) [and] and the vehicle (Vₙ₋₁) travelling in front of it.

Preferred embodiments of the process as claimed in the invention and the means as claimed in the invention are the subject matter of the dependent claims.

The invention (process and means) can be used with special advantage in transport systems with rail cars as are known from WO 02/04273 A1.

Other details and features of the invention will become apparent from the following description of embodiments using partially schematic drawings.

FIG. 1 shows a schematic view of vehicles which are moving along a roadway and which are equipped with the means as claimed in the invention,

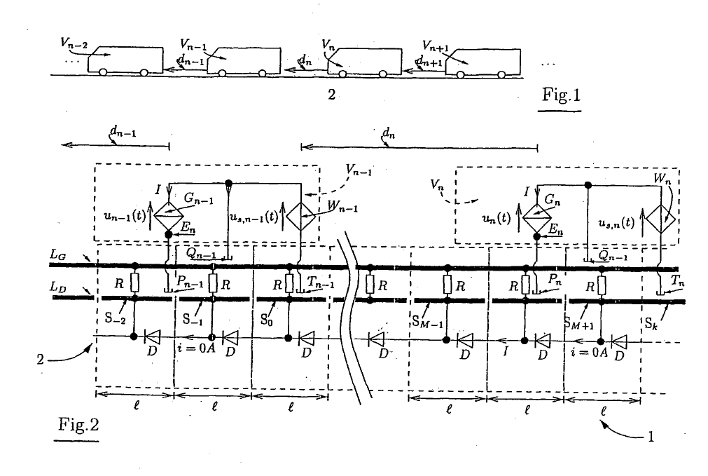

FIG. 2 shows a partially schematic view of the means as claimed in the invention,

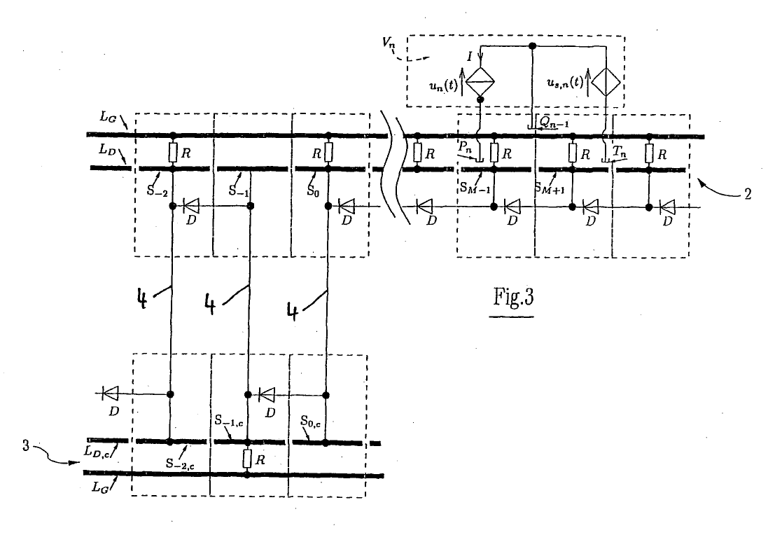

FIG. 3 shows a partial schematic view of the part of the means as claimed in the invention at the location at which the roadway forks,

FIGS. 4 to 6 show diagrams which show the behavior of signals which arise in the means as claimed in the invention and

FIG. 7 schematically shows the electrical conditions when the interval is being measured.

In FIGS. 1 and 2 a means 1 (arrangement) for measuring the interval (dₙ) between any two successive transport means (Vₙ) and (Vₙ₋₁) which are for example vehicles (highway vehicles, rail cars, etc.) from a host of vehicles (V) which are travelling in succession, for example in column at any speed on a (predetermined) distance 2 in a (certain) direction. It should be pointed out that the means as claimed in the invention also successfully works to measure the intervals between any two vehicles when the vehicles are stationary.

The means 1 has components which are stationary and for example are integrated into the roadway (road, highway, tracks, rails and the like) and furthermore has components which are provided on the vehicles.

The means 1 has a reference conductor (LG) and a measurement conductor (LD) which are placed along the roadway 2.

The reference conductor (LG) is an uninsulated line (collector wire) and can consists of rails or outdoor cables.

The measurement conductor (LD) is likewise an uninsulated line and consists of several successive separated segments (Sₘ), each segment (Sₘ) having a certain length (l).

The segments (Sₘ) of the measurement conductor (LD) are arranged in a row on the roadway parallel to the reference conductor (LG), their bordering ends being electrically insulated from one another by interruptions or insulating spacers. These spacers can consist of plastic or ceramic and have a length which is less than one third, preferably less than one one hundredth of the length (l) of the segments (Sₘ).

Each segment (Sₘ) is electrically connected to the preceding segment (Sₘ₋₁) by a diode (D), the conducting direction of the diode (D) agreeing with a predetermined direction of travel of the vehicles on the road 2.

Furthermore, each segment (Sₘ) of the measurement conductor (LD) is electrically connected via resistors (R) with a resistance of 50 Kohm to the reference conductor (LG).

The components of the means 1 as claimed in the invention which are provided on the vehicles (Vₙ) are movable electrical connections (contacts), for example sliding contacts, skids, or brushes, first connections (contacts Pₙ) and second connections (contacts Qₙ) and third connections (contact Tₙ) being provided.

Other components of the means 1 as claimed in the invention which are located on vehicles (Vₙ) are electrical generators (Gₙ and Wₙ). The generator (Gₙ) delivers a constant current. The generator (Wₙ) delivers variable voltages, for example voltages with sinusoidal behavior.

The first movable electrical contact (Pₙ) connects the first contact of the constant current generator (Gₙ) to a segment (Sₘ) of the measurement conductor (LD) which agrees with the position of the vehicle (Vₙ).

The second movable contact (Qₙ) connects the second contact of the constant current generator (Gₙ) and the first contact of the variable voltage generator (Wₙ) to the reference conductor (LG).

The third movable electrical contact (Tₙ) connects the second contact of the variable voltage generator (Wₙ) to the segment (Sₖ) of the measurement conductor (LD), this segment (Sₖ) lying downstream from the segment (Sₘ) with respect to the direction of travel of the vehicle.

In one alternative, it can be provided that the variable voltage generator (Wₙ) is replaced by a simple, direct electrical connection between the second movable contact (Qₙ) and the third electrically movable contact (Tₙ).

Within the framework of the invention, it is conventionally provided that the segment (Sₘ) with the first movable electrical contact (Pₙ) is separated from the segment (Sₖ) to which the third movable electrical contact (Tₘ) is assigned by two or more interposed segments (Sₘ), the number of segments (Sₘ) lying in between depending on the distance between the movable contacts.

The contacts of the constant current generator (Gₙ) constitute a two-pole output which delivers voltage signals which are correlated with the interval (dₙ) between the pertinent vehicle (Vₙ) and the vehicle (Vₙ₋₁) travelling ahead.

FIG. 3 shows one embodiment of the means as claimed in the invention in the region of a (road) fork or a (road) branch. Here one branch 3 branches off from the stretch 2. In this case the first three succeeding segments (Sₘ) of one branch 2 of the road is connected by interconnecting conductors 4 to the corresponding segments (Sₘ) of the other branch 3 of the road.

Successive interconnecting conductors 4 are connected to one another by a diode (D) and are each connected to the reference conductor (LG) of one branch 2 and that of the other branch 3 via resistors (R).

The means as claimed in the invention in one version for each vehicle (Vₙ) comprises a means for estimating the interval (dₙ), which can work in an analog or digital manner, and has an A/D interface which is connected to the output (Eₙ) and which is able to compute the estimated value (dₙ) of the interval.

The manner of operation of the process as claimed in the invention calls for evaluating the interval (dₙ) in the vehicle (Vₙ) using the voltage (uₙ) between the two contacts of the current source (Gₙ) which is qualitatively shown in FIG. 4 as a function of the interval (dₙ).

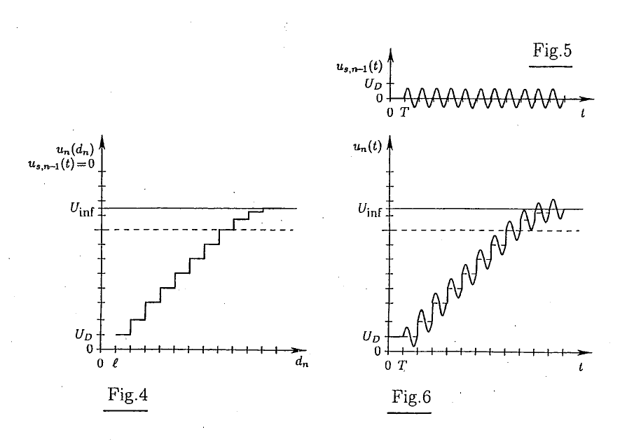

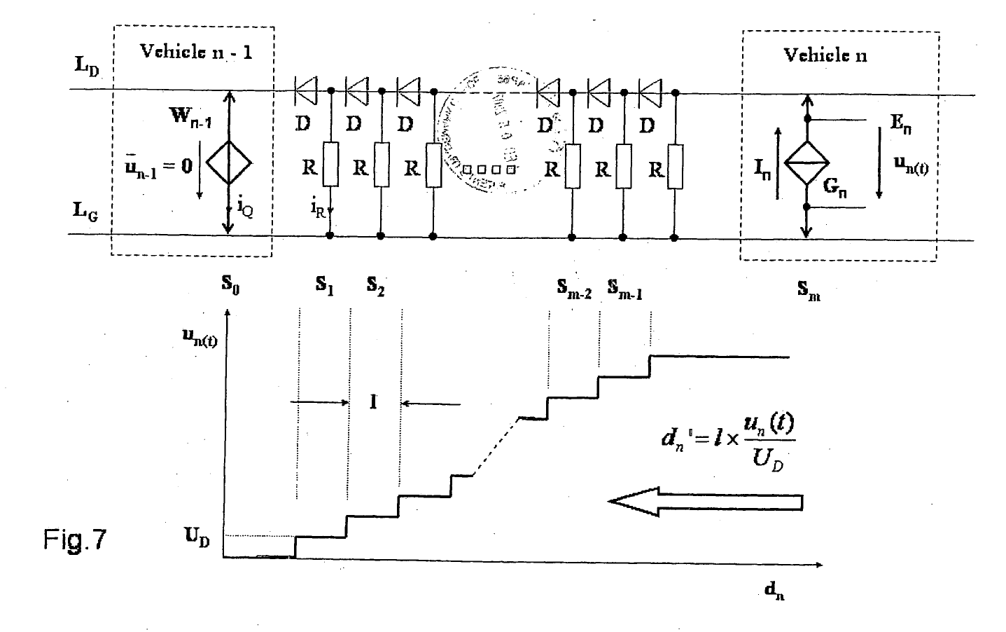

If in the preceding vehicle (Vₙ₋₁) a signal u_{sn-1/(t)} which is the voltage on the contacts of the generator (Wₘ₋₁) is modulated on as shown in FIG. 5, such a signal can be produced again in the vehicle (Vₙ) from the signal (uₙ₍ₜ₎) as shown in FIG. 6, on the terminals of the generator.

In this case a short term average (Uₙ) is computed from (uₙ₍ₜ₎) in order to estimate the interval (dₙ).

The average (Uₙ) must be re-computed for any change of the interval (dₙ).

In order to demodulate (U_{s,n1(t)}, at least the average value (uₙ₋₁) of the same signal in the vehicle (Vₘ) must be known beforehand.

Furthermore it is assumed that the current in the measurement conductor (I_{d}) between (Tₙ) and Pₙ) is always zero.

Generally (Uₙ) is a monotonically increasing function of the interval (dₙ) as is shown in FIG. 4.

In order to evaluate the measured value (Uₙ), within the framework of the invention it is advantageously provided that this function be divided into three regions. A linear region, a non-linear region and an “open circuit” region.

In this way, in addition to distance measurement, it can also be established whether there is a preceding vehicle or whether there is an interruption in the circuit.

The exact subdivision of these regions depends on the value of the resistor (R) and on the type of diode (D).

Measurements in the Linear Region:

For short intervals (Uₙ) increases in a staggered manner, as is shown in FIG. 4.

In this case the interval can be estimated with the formula dₙ=1·(Uₙ−U_{n, n-1}/Uₙ with an accuracy of +/−1; this corresponds at most to an error in the length of a segment (Sₙ). In this case the voltage (Uₙ) is the voltage difference between the terminals of each of the diodes (D), of which the same current intensity (I) flows through each.

In the linear segment the voltage (U_{e,n-1}(t) in the vehicle (Vₙ) can be demodulated according to formula u_{s,n-1}(t)=U_{s,n}−Uₙ+uₙ(t).

Measurements in the Nonlinear Region:

When the interval (dₙ) between one vehicle Vₙ and a vehicle travelling in front of it (Vₙ₋₁) is increased, the interval (dₙ) does not increase linearly with (Uₙ); this means that the steps become smaller and smaller, as is shown in FIG. 4 between the horizontal broken and the horizontal solid line.

If (dₙ) tends toward infinity, the voltage (Uₙ) approaches the boundary value (U_{inf}).

When (Uₙ=U_{inf}), this means that there is no vehicle (Vₙ₋₁) travelling in front of vehicle (Vₙ) or that it is very far away.

Measurements in the “Open Circuit” Region:

If the circuit between the contacts of the constant current generator (Gₙ), i.e. those of the reference conductor (LG), the measurement conductor (LD) and the movable contacts Pₙ, Qₙ, Tₙ between two successive vehicles (Vₙ and Vₙ₋₁) is open, (Uₙ) reaches a higher value than (U_{inf}).

FIG. 7 again illustrates the electrical conditions and movement of the car (Vₙ) which measures its interval to the car travelling in front of it (Vₙ₋₁). The current source of the car (Vₙ) injects the measurement current (Iₙ) into the measurement rail (LD), which current flows to the left based on the selected polarity of the diode chain. If there is no car in the measurement region, the voltage (Uᵢₗₗ) is set at the measurement point (Eₙ). But if the car (Vₙ₋₁) is within the detection region, part of the measurement current (Iₙ) is DC voltage-short-circuited by the voltage source of the car (Vₙ₋₁). An injected signal voltage (Uₙ₋₁(t)) can be decoupled via the corresponding filter and evaluated. The short circuit reduces the voltage to (uₙ(t)). As soon as the measurement voltage is below (Uₗᵢₙ), thus is in the linear range, the car (Vₙ) can now compute the estimated value of the interval to the car (Vₙ₋₁) by measuring the voltage on the current source (uₙ(t)) according to the simplified formula (dₙ=1*uₙ(t)/U_{D}). Upon approaching the car (Vₙ₋₁), the measured voltage (uₙ(t) will be reduced in a staggered manner by the forward voltage of a diode (U_{D}) for each transition to the next segment.

It should be noted that the accuracy of interval measurement can be increased by the height of the steps, i.e. the forward voltage of the diodes, being additionally measured. This is dependent mainly on the temperature.

It should furthermore be noted that the measurement current I determines the range of measurement. It must be dimensioned for measurement in the linear region such that the current through the voltage source (i_{Q}) is much greater than the current through the resistors (i_{R}). If this condition is satisfied, (uₙ(t)) will be almost independent of the measurement current (I). The car (Vₙ) can moreover check this by its changing the measurement current (I) in its magnitude and checking the effect on the measurement value (uₙ(t)).

It should furthermore be noted that the direction of the measurement can be reversed by reversing the polarity of the measurement current (I). In this way it is possible to use the interval measurement process as claimed in the invention for both directions of travel of the cars.

It should moreover be noted that the measurement accuracy continuously increases as the interval becomes smaller since the ratio of (U_{D}) to the measured voltage (uₙ(t)) increases.

It is advantageous that the means of the invention is reliable with respect to two types of possible faults:

An interruption in the reference conductor (LD) or in the measurement conductor (LG) between successive vehicles (Vₙ and Vₙ₋₁) can be identified according to the process described in the “open circuit”. If one or more diodes (D) have a short circuit, the measured interval (dₙ) is always shorter than the actual interval. This fact is regarded as safe for anticollision systems.

One advantage of the invention is a simple and reliable means for measuring the interval between vehicles which is moreover able to accommodate anomalies and faults.

In the determination of the interval between vehicles as claimed in the invention using the means as claimed in the invention, a process is used which is based on measuring the forward voltage of the diode chain. Semiconductor diodes in the forward direction have a characteristic which is characterized in that the diode is not an ideal switch, but that in the forward direction a voltage drop (UD) is established which is essentially logarithmically dependent on the current.

At this point the measurement principle is based on the fact that between the current sliders of two cars (vehicles) travelling in succession a measurement current (I) is injected and then a voltage is measured which is n.UD, (n) being the number of segments (Sₘ) of the interrupted collector wire (LD) with a length (l) (i.e. the forward voltage of the diode chain). The interval between the cars is therefore equal to the product of the length (l) of the segments (Sₘ) of the collector wire (LD) and the measured voltage (Uₘₑₐₛ) divided by the voltage drop over the diode (UD) (1*Uₘₑₐₛ/UD) (this yields a diagram according to the step curve from FIG. 4 in which the step width corresponds to the length (l) of the segments (Sₘ)). In the lower region the step is approximately, but not entirely linear through the resistors (R). The nonlinear region in the upper part is based on the fact that part of the injected measurement current in any segment is diverted via the resistor (R). At some time then there is no longer any current there and the forward voltage becomes smaller over the last diodes of the measurement region, as mentioned above. The measurement current (I) defines not only the range of the measurement, but the result in itself.

One advantage in the means as claimed in the invention is that by using diodes decoupling takes place so that each car can measure the interval to the car travelling in front of it. This advantage is caused by the blocking characteristic of the diodes, i.e. those diodes which are located between the two segments (Sₘ) with which the same car has made contact (front and back sliding contact) are polarized beforehand in the blocking direction. The length (l) of the segments (Sₘ) must therefore always be smaller than the distance between the front and rear sliders of a car. Thus the situation arises that all diodes are polarized in the forward direction between two cars and can thus be used to measure the interval. The diodes underneath the car are however polarized in the blocking direction and thus the measurement segments are decoupled from one another.

In summary, one embodiment of the invention can be described as follows:

Means for measuring the interval (dₙ) between any vehicle (Vₙ) of a host of vehicles (V) and the vehicle (Vₙ₋₁) travelling in front of it along a (defined) stretch and for a (certain) direction.

The means 1 along the indicated stretch contains a reference conductor (LG) and a measurement conductor (LD), the latter consists of a host of successive segments (Sₘ) which are separated from one another and which have a predetermined length l. Each segment (Sₘ) is electrically connected to the preceding segment (Sₘ) by a diode (D).

In each vehicle (Vₙ) there is a constant current generator (Gₙ) of the means 1 with contacts which are each connected to the segment (Sₘ) of the measurement conductor (LD) which corresponds to the position of the vehicle (Vₙ) and to the reference conductor (LG) by first movable electrical contacts (Pₙ) and by second movable electrical contacts (Qₙ).

Each second electrical contact (Qₙ) is connected by a corresponding third movable electrical contact (Tₙ) to a segment (Sₖ) which follows the segment (Sₘ), relative to the direction downstream from the first electrical contact (Pₙ).

The contacts of the constant current generator (Gₙ) form an output (Eₙ) which makes available a voltage signal which is correlated with the interval (dₙ) between the referenced vehicle (Vₙ) and the vehicle (Vₙ₋₁) travelling in front of it.

1. Means for measuring the interval (dₙ) between one vehicle (Vₙ) and another vehicle (Vₙ₋₁), the two vehicles travelling on a stretch, characterized in that along the stretch on which the vehicles (Vₙ) and (Vₙ₋₁) are moving there are a reference conductor (LG) and a measurement conductor (LD), that the measurement conductor (LD) is formed from several of segments (Sₘ) which are separated from one another, with a length 1, that the segments (Sₘ) of the measurement conductor (LD) are connected to adjacent segments (Sₘ₋₁) by a diode (D), that in each vehicle (Vₙ) there is a constant current generator (Gₙ), that the contacts of the constant current generator (Gₙ) are connected to the segment (Sₘ) of the measurement conductor (LD) which corresponds to the respective position of the vehicle (Vₙ) on the one hand and to the reference conductor (LG) on the other hand by first movable electrical contacts (Pₙ) and by second movable electrical contacts (Qₙ), that the second electrical contact (Qₙ) is connected by a third movable electrical contact (Tₙ) to a segment (Sₖ) which follows the segment (Sₘ) and which is located relative to the direction of travel downstream from the first electrical contact (Pₙ), that the terminals of the constant current generator (Gₙ) form an output (Eₙ) which delivers a voltage signal which is correlated with the interval (dₙ) between the vehicle (Vₙ) and the other vehicle (Vₙ₋₁).

2. Means as claimed in claim 1, wherein each segment (Sₘ) is electrically connected via a resistor (R) to the reference conductor (LG).

3. Means as claimed in claim 2, wherein the resistor (R) has a value of more than 50 Kohm.

4. Means as claimed in claim 1, wherein in each vehicle (Vₙ) there is a variable voltage generator (Wₙ) which is connected in series to the connection between the second electrical contact (Qₙ) and the third electrical movable contact (Tₙ).

5. Means as claimed in claim 1, wherein the ends of successive segments (Sₘ) are electrically insulated from one another by interruptions or insulating spacers.

6. Means as claimed in claim 5, wherein the length of the interruptions between successive segments (Sₘ) of the measurement conductor (LD) is less than half of the length (l) of the segments (Sₘ).

7. Means as claimed in claim 1, wherein in the area of the branching of the stretch into at least one first branch (2) and a second branch (3), after the branching at least one segment (Sₘ) of the first branch (2, 3), which segment follows the branches (2,3), is connected to the corresponding segment (Sₘ) of the other branch (3, 2) by interconnecting conductors (4).

8. Means as claimed in claim 7, wherein at least three of the segments (Sₘ) of the first branch (2, 3) which follow the branching are connected to the corresponding segments (3, 2) of the other branch (3, 2).

9. Means as claimed in claim 2, wherein the interconnecting conductors are connected in turn to a single diode (D) and alternately to the reference conductor (LG) of one branch (2, 3) or the other over a resistor (R).

10. Means as claimed in claim 1, wherein all segments (Sₘ) have the same length (l).

11. Means as claimed in claim 1, wherein all diodes (D) have essentially the same electrical properties.

12. Means as claimed in claim 1, wherein the current intensity of the constant current generator (Gₙ) of the means is adjustable in operation.

13. Means as claimed in claim 1, wherein the polarity of the constant current generator (Gₙ) of the means is selectable in operation.

14. Process for determining the interval between two transport means (Vₙ) using the means as claimed in claim 1, wherein the estimated value for the interval dₙ) to the vehicle travelling in front is determined from the DC voltage portion of the measured value of the voltage (uₙ(t)) on the terminal (Eₙ) by division by the forward voltage of the diodes (U_{D}) and multiplication by the length (l) of the segments (Sₘ).

15. Process as claimed in claim 14, wherein the forward voltage of the diodes is determined by at least one measurement of the voltage difference of the DC voltage portion of the measured value of the voltage (uₙ(t)) before and after the transition from one segment (Sₘ) to the next segment (Sₘ₋₁).

16. Means as claimed in claim 2, wherein in each vehicle (Vₙ) there is a variable voltage generator (Wₙ) which is connected in series to the connection between the second electrical contact (Qₙ) and the third electrical movable contact (Tₙ).

17. Means as claimed in claim 3, wherein in each vehicle (Vₙ) there is a variable voltage generator (Wₙ) which is connected in series to the connection between the second electrical contact (Qₙ) and the third electrical movable contact (Tₙ).
